(19) United States
(12) Patent Application Publication
(10) Pub. No.: US 2004/0259056 A1
(43) Pub. Date: Dec. 23, 2004

(54) Prosthetic implant

(76) Inventor: Robert Holt, West Palm Beach, FL (US)

Correspondence Address: Stanley A. Kim, Ph.D., Esq., Ruden, McClosky, Smith, Schuster & Russell, P.A., Suite #800, 222 Lakeview Avenue, West Palm Beach, FL, 33401-6112, US

(21) Appl. No.: 10/723,209

(22) Filed: Nov. 24, 2003

Related U.S. Application Data
(63) Continuation of application No. 10/060,553, filed on Jan. 30, 2002, now abandoned.
Application No. 10/060,553 is a continuation of application No. 09/705,240, filed on Nov. 2, 2000, now abandoned.
(60) Provisional application No. 60/242,391, filed on Oct. 21, 2000.

(51) Int. Cl. A61C 8/00

(52) U.S. Cl. 433/173

(57) ABSTRACT

Disclosed is a prosthesis including a bone anchor having a curvilinear platform.

### CROSS REFERENCE TO RELATED APPLICATIONS

The present application is a continuation of U.S. patent application Ser. No. 10/060,553 filed Jan. 30, 2002, which is a continuation of U.S. patent application Ser. No. 09/705,240 filed Nov. 2, 2000 which claims the priority of U.S. provisional patent application 60/242,391 filed Oct. 21, 2000.

### STATEMENT AS TO FEDERALLY SPONSORED RESEARCH

Not Applicable.

### FIELD OF THE INVENTION

The invention relates generally to the field of prosthetics, dentistry and surgery. More particularly, the invention relates to prostheses that can be implanted in a bone.

### BACKGROUND

In several different medical procedures, prosthetic devices are attached to a patient by bone anchors. As a common example of this, dental prostheses including artificial teeth (e.g., crowns and bridges) have been successfully secured in a patient's mouth by anchoring an implant portion of a prosthesis in the patient's jaw bone (e.g., mandible or maxilla). Such implants are generally available in one-stage and two-stage designs.

One-stage implants are single component devices that have one end designed to be inserted into the jawbone, and another end designed to attach to an artificial tooth. A typical surgical procedure for a one-stage implant includes the steps of preparing a socket in the jawbone by drilling a hole therein; anchoring the implant in the prepared socket; and then securing an artificial tooth to the end of the implant projecting through the gingiva. Such one-stage implants may be proven problematic if the artificial tooth is subjected to displacement (e.g., from jarring during chewing) before the socket has completely healed. Displacement of the implant during the healing process can lead to implant failure because the implant does not become firmly affixed within the socket or it becomes affixed in an improper orientation.

To circumvent this problem, two-stage implants have been devised that include both a bone anchor component which can be inserted into the jawbone and an abutment component (e.g., cover screws, or posts, adapters, and connectors) having one end that can be attached to the bone anchor and another end that can be attached to an artificial tooth. A typical surgical procedure for a two-stage implant includes the steps of preparing a socket in the jawbone; anchoring the bone anchor component in the prepared socket; optionally, covering the bone anchor with flaps of gingival tissue; allowing the socket to heal so that the bone anchor component is rigidly affixed to the bone; attaching the abutment component to the bone anchor component; and then securing an artificial tooth to the end of the abutment component.

In many types of two-stage implants, the abutment component is designed to fit within bores formed through the bone anchor and the artificial tooth such that the three components can be assembled into a single unit prosthesis. When assembled, the prosthesis has the abutment component firmly seated against a shoulder or platform portion of the bone anchor near the surface of the bone. Two joints are thus usually created among the components of the prosthesis- a first joint formed between the artificial tooth and the abutment (i.e., the “tooth-abutment” joint), and a second joint formed by the abutment to the bone anchor (i.e., the “abutment-bone anchor” joint). In some designs, e.g., where the abutment connects to an internal indexing device within the bone anchor, the artificial tooth is firmly seated against the platform portion of the bone anchor. In these designs, a third joint is created (i.e., the tooth-bone anchor joint).

Proper positioning of these joints, especially the abutment-bone anchor joint and the tooth-bone anchor joint, is important in achieving a successful result. For example, positioning the abutment-bone anchor joint or the tooth-bone anchor joint too close to the bone or beneath the external surface of the bone will lead to bone loss at the anchoring site. Stable bone is important to implant retention, and it is critical to prosthesis esthetics. To prevent bone loss, the distance between the abutment-bone anchor joint (or the tooth-bone anchor joint) and the external surface of the bone can be increased. If this distance is increased too much, the abutment/anchor will interfere with proper placement of the artificial tooth, resulting in an unesthetic appearance of the prosthesis or worse, a non-functional prosthesis. Ideally then, the abutment-bone anchor joint and/or the tooth-bone anchor joint should be aligned with the natural contour of the bone at the site of implantation. Healthy bone tends to follow a curvilinear course around the circumference of a tooth or an implant, with the gingiva covering the bone and forming a similar curvilinear path around natural teeth at a level of about 2-5 millimeters coronal (external) to the bone. Within this 2-5 mm zone of gingiva, implant joints and margins of artificial teeth exist in health and esthetic harmony.

Heretofore, achieving the ideal positioning of the abutment-bone anchor joint or tooth-bone anchor joint using conventional two-stage implants has been difficult because (a) such implants utilize a bone anchor having a flat platform and (b) most bone surfaces are curved. Thus, flat-shouldered, conventional bone anchors could not be precisely aligned with a curved bone surface.

### SUMMARY OF THE INVENTION

What has been developed is a prosthetic bone anchor having a curvilinear (i.e., non-flat) platform. The curvilinear platform closely mimics the curved contour of typical bone surfaces, allowing a more precise alignment of the prosthesis abutment-implant joint with the external surface of the bone. The curvilinear platform, therefore, makes it easier to achieve an ideal placement of the bone anchor in the implant site. Thus, in comparison to conventional flat-platformed bone anchors, those of the invention provide improved indexing, enhanced esthetics, superior bone stability, and improved implant retention. In the case of one-stage implants, the curvilinear platform is similarly positioned just external to the bone contours.

Several different variations of curvilinear-platformed bone anchors are within the invention. These variations differ according to the intended use. For example, for use with highly arched, relatively thin bone surfaces, the platform is relatively small with a high degree of curvature. For use with less arched and relatively thick bone surfaces, the platform is larger with a lower degree of curvature. The size of the platform can vary from very small to very large, and its curvature can vary from concave to convex, regular (e.g., hyperbolic, parabolic, or sinusoidal) or irregular. The bone anchors of the invention can vary in format as do conventional bone anchors. For example, the present bone anchors can have an abutment engagement device configured in an internal polygonal (e.g., hexagonal or octagonal), external polygonal (e.g., hexagonal or octagonal), internal tapered, or beveled design.

Abutments and artificial teeth for use with the bone anchors of the present invention are designed to operate in accord with the curvilinear-platform. Thus, the portion of the abutment or artificial tooth that contacts the platform is designed in a size and shape that complements (fits flushly with) the curvilinear platform of the bone anchor.

Accordingly, the invention features

a bone anchor for use in a prosthesis. The bone anchor has a bone attachment portion adapted to secure the bone anchor in a bone and a platform portion having a non-flat top surface. The foregoing bone anchor can be used in a two-stage dental prosthesis that includes the bone anchor and an abutment or artificial tooth having a platform engagement portion that can be flushly mated with the platform portion of the bone anchor. In this version, the bone anchor features an abutment acceptor adapted to engage the abutment or artificial tooth.

The non-flat top surface of the platform portion of the bone anchor can have a variety of shapes. For example, it can have a curvilinear shape, a convex hyperbolic shape, a regular curvilinear shape, an irregular curvilinear shape, a concave shape, or a shape made up of at least two non-parallel flat surfaces.

The bone anchors of the invention can also have an indexing device. The indexing device can be similar to those featured in conventional flat-platformed bone anchors. For example, the indexing device can be in an external polygonal, an internal polygonal, or an internal tapered format.

In another aspect, the invention features a dental prosthesis including a bone anchor, an abutment, and an artificial tooth. In this prosthesis, the bone anchor includes a first abutment acceptor adapted to engage the abutment, and a platform portion having a non-flat top surface. The abutment has a bone anchor connection portion adapted to engage the first abutment acceptor, a platform engagement portion that can be flushly mated with the platform portion of the bone anchor, and an artificial tooth connection portion adapted to engage the artificial tooth. The artificial tooth includes a second abutment acceptor adapted to engage the abutment.

In yet another version, the bone anchors of the invention have an abutment acceptor adapted to engage the abutment, and a non-flat, curvilinear shaped platform engagement portion that mates flushly with the margin of the artificial tooth. In this version the abutment connects only into the abutment acceptor portion of the bone anchor, leaving the peripheral non-flat, curvilinear platform exposed.

In various versions of the prosthesis, the non-flat top surface of the platform portion of the bone anchor has a curvilinear shape, and the platform engagement portion of the abutment has a bottom surface having a shape complementary to the non-flat top surface of the platform portion of the bone anchor. For example, the platform portion of the bone anchor can have a convex hyperbolic shape, a regular curvilinear shape, an irregular curvilinear shape, a concave shape, or a shape made up of at least two non-parallel flat surfaces.

Also within the invention is a kit that includes at least a first bone anchor for use in a prosthesis and a second bone anchor for use in a prosthesis. The first and second bone anchors each have a bone attachment portion being adapted to secure each bone anchor in a bone, and a platform portion having a non-flat top surface. The first and second bone anchor differ from each other in at least one dimensional parameter such as size and shape.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. Other features and advantages of the invention will be apparent from the following detailed description, and from the claims.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1A is an exploded schematic side view of a first embodiment of a dental prosthesis of the invention bone anchor having a non-flat platform, an abutment that mates with the non-flat platform, and an artificial tooth.

FIG. 1B is an exploded schematic side view of a second embodiment of a dental prosthesis of the invention having bone anchor having a non-flat platform, an abutment, and an artificial tooth that mates with the non-flat platform.

FIG. 1C is an exploded schematic side view of a third embodiment of a dental prosthesis of the invention having bone anchor with a non-flat platform, an abutment that mates with the non-flat platform, an artificial tooth, and an indexing device.

FIG. 2 is a cross-sectional view of the embodiment of FIG. 1A implanted in bone with the bone anchor, abutment, and artificial tooth shown assembled together.

FIG. 3 is a more detailed cross-sectional view of an embodiment of a bone anchor of the invention.

FIG. 4 is a schematic side view of an embodiment of a dental prosthesis of the invention with a bone anchor having three non-parallel flat surfaces.

FIGS. 5A-10B show schematic and cross-sectional views various embodiments of bone anchors within the invention.

### DETAILED DESCRIPTION

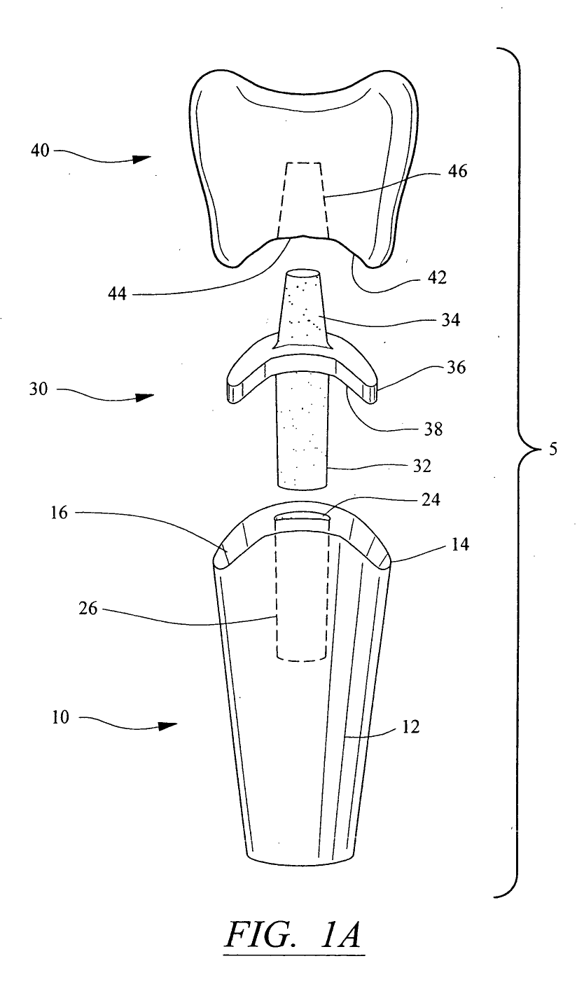

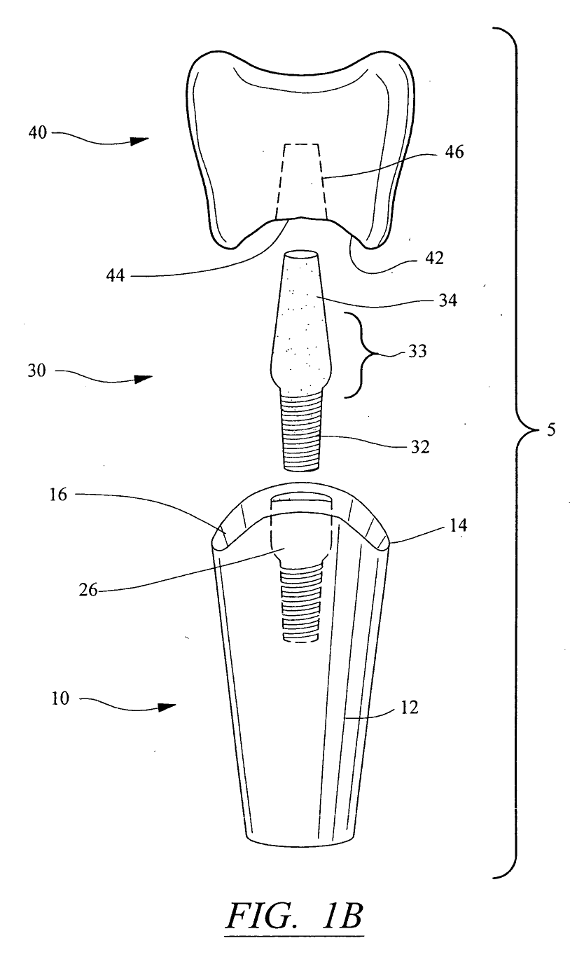

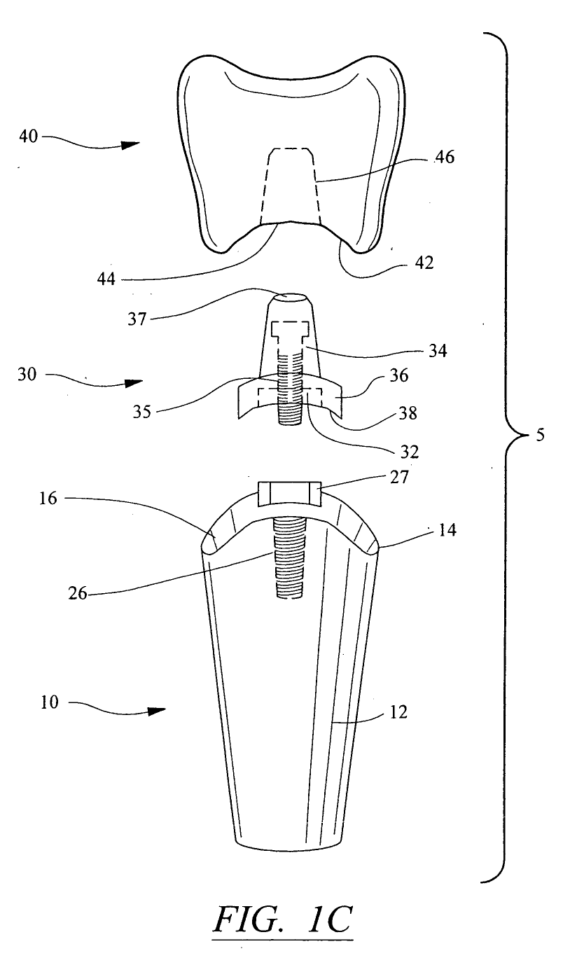

In brief overview, referring to FIG. 1A, a first exemplary embodiment of a prosthesis 5 is shown with a two-stage implant that includes bone anchor 10, an abutment 30, and an artificial tooth 40. Bone anchor 10 is typically a single piece made of a dentally acceptable metal such as titanium. It includes a bone attachment portion 12 that can be used to hold anchor 10 in the bone, a non-flat platform 14 above (in the orientation shown in FIG. 1A) the bone attachment portion 12, a top surface of the platform 16, an aperture 24, and an abutment acceptor 26 for engaging the abutment 30. Abutment 30 is also typically a single piece made of a dentally acceptable metal or porcelain. It features an anchor connection portion 32, an artificial tooth connection portion 34, and a platform engagement portion 36 which has a bottom surface of platform engagement portion 38. In this embodiment, the bottom surface 38 of portion 36 has a shape that is the complement of the top surface 16 of the non-flat platform 14 such that when prosthesis 5 is assembled, bottom surface 38 mates flushly with top surface 16. Artificial tooth 40 is constructed similarly to a conventional single crown or bridge (e.g., having an optional base made of a dentally acceptable metal and coating made of porcelain). Tooth 40 features a bottom surface 42, a tooth aperture 44, and an abutment acceptor 46.

Other exemplary embodiments of the prosthesis 5 are shown in FIGS. 1B and 1C. Like the embodiment of FIG. 1A, the prosthesis 5 shown in FIG. 1B is a two-stage implant including a bone anchor 10, an abutment 30, and an artificial tooth 40. The abutment 30 shown in FIG. 1B, however, lacks the platform engagement portion 36 of the prosthesis shown in FIG. 1A. Instead, in this embodiment, abutment 30 features an anchor connection portion 32, and artificial tooth connection portion 34, and a transition area 33 between the portions 32 and 34. The transition area 33 is shaped to fit within the abutment acceptor 26 of the bone anchor 10. In this embodiment, the artificial tooth 40 features a bottom surface 42 which fits and mates to the non-flat platform 14 of the bone anchor 10 when the prosthesis 5 is assembled.

Referring to FIG. 1C, a third exemplary prosthesis 5 is also a two stage implant bone anchor 10, an abutment 30, and an artificial tooth 40. This embodiment is similar to the one shown in FIG. 1A, except that rather than employing a protruding anchor connection portion to connect the abutment 30 to the anchor 10, it uses an abutment retention screw 35 that can be inserted through an orifice 37 located at the top of the abutment 30 (having a bore through its length) to engage a screw acceptor 26. In this embodiment, an indexed anchor connector portion 32 is shaped to mate with an abutment engagement head 27 when the prosthesis 5 is assembled. As with the embodiment of FIG. 1A, the bottom surface 38 of portion 36 has a shape that is the complement of the top surface 16 of the non-flat platform 14 such that when prosthesis 5 is assembled, bottom surface 38 mates flushly with top surface 16.

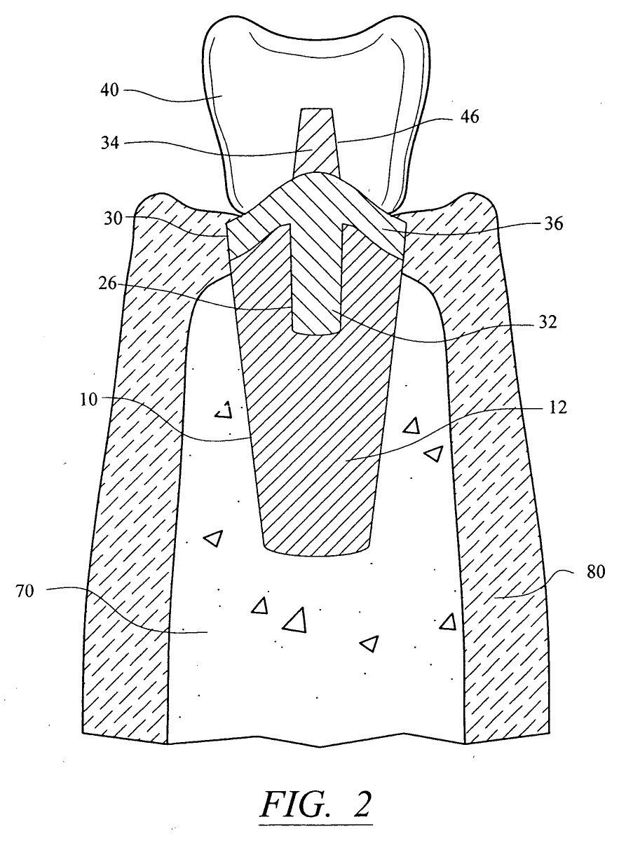

Referring now to FIG. 2, the prosthesis 5 of the embodiment shown in FIG. 1A is shown with the bone anchor 10, the abutment 30, and the artificial tooth 40 assembled together and implanted within a bone arch 70 and surrounded by gingiva 80. To facilitate assembly, referring again to FIG. 1A, the abutment acceptor 26 of the bone anchor 10 features an aperture 24 through which the anchor connection portion 32 of the abutment 30 can be inserted into the abutment acceptor 26, a bore through the length of the bone anchor 10 configured such that the bone anchor 10 can be mated with the abutment 30. Similarly, the tooth connection portion 34 can be inserted through the aperture 44 (not shown) into the abutment acceptor 46, a bore that extends through a portion of the length of the tooth 40 and is configured such that the tooth 40 can be mated with the abutment 30.

In the embodiments shown in FIGS. 1A, 1C, and 2, the top surface 16 of the platform 14 of the bone anchor 10 and the bottom surface of platform engagement portion 38 of the abutment 30 are both curvilinear (i.e., not flat). In the embodiment shown in FIG. 1B, the top surface 16 of the platform 14 of the bone anchor 10 and the bottom surface 42 of the tooth 40 are both curvilinear (i.e., not flat). In these embodiments, the shapes of surfaces 16 and 38 (or 16 and 42 when referring to the embodiment shown in FIG. 1B) are complementary, such that the joint between them is flush when the prosthesis 5 is assembled. For example, in the versions shown in FIGS. 1A, 1C, and 2, the top surface of the platform 16 has a regular (i.e., definable by a mathematical formula) convex hyperbolic curvature, and the bottom surface of platform engagement portion 38 has a regular, concave (complementary to the convexity of the top surface 16) hyperbolic curvature. Thus, when the bone anchor 10 and the abutment 30 are mated, the joint between surfaces 16 and 38 is flush. In the same fashion, referring to the embodiment shown in FIG. 1B, top surface 16 has a regular convex hyperbolic curvature that is the complement of the curvature of bottom surface 42 such that when bone anchor 10 and tooth 40 are mated, the joint between surfaces 16 and 42 is flush.

The curvature of surfaces 16 and 38 or 42 are not limited in shape to regular hyperboloids. Rather each can be of any non-flat configuration. Preferred curvatures are those that mimic the curvature of the external surface of a bone. Thus, given the arched nature of the human mandible and maxilla, for dental prostheses, a convex hyperbolic or parabolic shape is generally preferred for top surface 16, and a concave hyperbolic or parabolic shape is generally preferred for bottom surface 38 or 42. Other configurations for surfaces 16 and 38 or 42 are preferred depending on the intended use or site of implantation of the prosthesis. For example, for an external bone surface that is relatively flat on a first side and relatively curved on a second side, preferred versions of the surfaces 16 and 38 or 42 are those that mimic this irregular curvature, i.e., with the side of each of the surfaces 16 and 38 or 42 to be aligned with the first side of the bone surface being relatively less curved than the side of each of the surfaces 16 and 38 or 42 to be aligned with the second side of the bone surface.

Neither is the curvature of top surface 16 limited to being convex or the curvature of bottom surface 38 or 42 limited to being concave. Rather each surface can be of any non-flat curvature. For example, where the external surface of the bone at the implant site is depressed or concave, top surface 16 can be concave and bottom surface 38 or 42 convex. Others examples of bone curvature are provided in Grey's Anatomy; Dental Anatomy: Its Relevance to Dentistry, Julian B. Woelfel and Rickne C. Scheid, 5th Edition, Lippincott, Williams & Wilkins, 1997; Grant, J. C. B., An Atlas of Anatomy, The Williams and Wilkins Co., Baltimore, 1962 (especially FIGS. 460 and 461); and Wheeler's Dental Anatomy, Physiology, and Occlusion, M. Major Ash, 7^{th} Edition, W. B. Saunders Co., 1992.

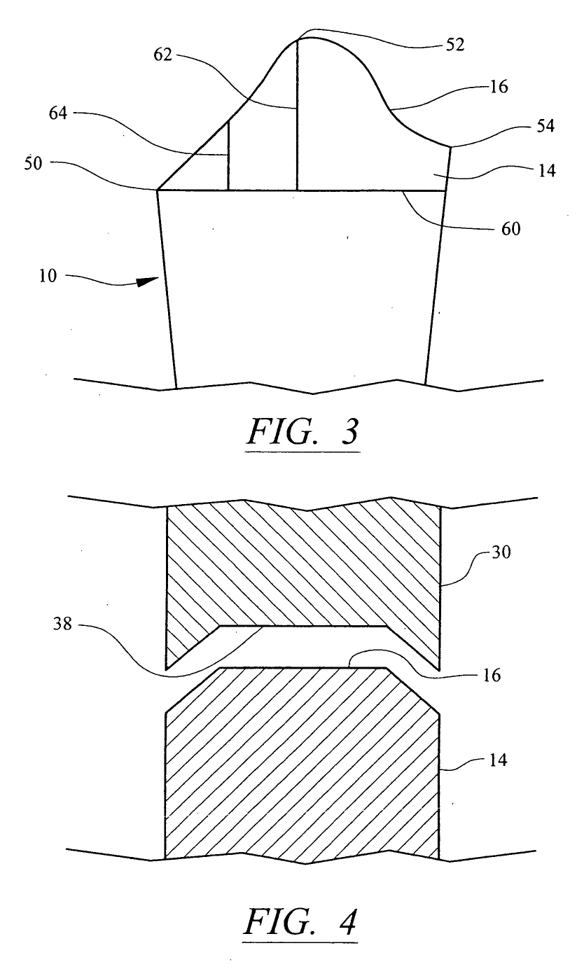

For example, referring to FIG. 3, platform 14 is shown in cross section with the top surface 16 of platform 14 including a first side point 50, a midpoint 52, and a second side point 54. The foregoing points are arbitrary points located on three different portions of surface 16 in order to illustrate some variations of the curvature of surface 16. Baseline 60 (shown along the width of platform 14 and intersecting the first side point 50), height 62 (the vertical distance between baseline 60 and midpoint 52), and height 64 (the vertical distance between baseline 60 and second side point 54) are not structural features of the platform 14, but rather are hypothetical lines shown for the purposes of relative dimensional reference. The width of platform 14 (baseline 60) can be any suitable for use in a bone implant. For use in human dental prostheses, the width of the baseline 60 will vary depending on the size of the bone arch at the implant site. This will differ depending on the size of the tooth being replaced, the patient size, the presence of disease at the site, etc. See, e.g., Dental Anatomy: Its Relevance to Dentistry; An Atlas of Anatomy; and Wheeler's Dental Anatomy, Physiology and Occlusion, supra.

Baseline 60 or the width of platform 14 can be any suitable for use in a prosthesis. Preferred widths of the baseline 60 range from about 1 mm to about 5 cm. For dental applications, suitable lengths of the baseline 60 range from about 1 mm to 15 mm (e.g., 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10, 11, 12, 13, 14, 15, and 16 mm). Likewise, heights 62 and 64 along surface 16 can be any suitable for use in a prosthesis. Preferred heights 62 and 64 range from about 0.1 mm to about 10 mm. For many dental applications heights 62 and 64 that range from about 1 mm to about 3 mm (e.g., 0.9, 1.0, 1.1, 1.2, 1.3, 1.4, 1.5, 1.6, 1.7, 1.8, 1.9, 20, 2.1, 2.2, 2.3, 2.4, 2.5, 2.6, 2.7, 2.8, 2.9, 3.0, and 3.1 mm) are preferred as these are compatible with human dental anatomy. Height 62 can be greater, less than, or equal to height 64. In addition, to further define the curvature of surface 16, several more points along surface 16 analogous to points 52 and 54 could be made. These could vary in height with one another to yield an almost infinite number of curvatures for surface 16, each of which is also within the invention. In the same fashion, bottom surface 38 of abutment 30 (or the bottom surface 42 of tooth 40) could have any curvature that is not flat, such that surfaces 16 and 38 (or 42) can be flushly aligned.

In other versions of the invention, referring to FIG. 4, the curvature of surfaces 16 and 38 (or 42 for the embodiment shown in FIG. 1B) is formed by at least two non-parallel flat surfaces. In FIG. 4, surface 16 is formed by three non-parallel flat surfaces. Surface 38 has a complementary shape also formed by three non-parallel flat surfaces. Surfaces 16 and 38 can have 2, 3, 4, 5, 6, 7, 8, 9, 10 or more flat surfaces that when combined approximate the curvature of the bone surface where the prosthesis is to be implanted. Using at least two non-parallel flat surfaces to form the curvilinear shape of surfaces 16 and 38 facilitates manufacturing of the bone anchor 10 and the abutment 30 because both can be shaped by simply milling or grinding flat edges on the bone anchor 10 and abutment 30. And although the overall shape of the circumferences of surfaces 16 and 38 (if looking down upon platform 14 or up at abutment 30 in the orientation shown in the figures) is shown in the figures as circular, it can be any shape suitable for use in a bone implant prosthesis. For example, it could be elliptical, polygonal (e.g., triangular, square, pentagonal, hexagonal, rhomboid, etc.), or irregularly shaped. The format most suitable will depend on the particular application.

In another aspect of the invention, the platform 14 of the bone anchor 10 and/or the platform engagement portion 36 of the abutment 30 are composed of a millable (e.g., grindable or otherwise shapeable) rigid composition such as a metal (e.g., pure titanium, a titanium alloy, or a gold alloy). Such components could be milled by a dentist, surgeon, or technician to the precise curvature desired for a given application.

Also within the invention are kits composed of a plurality of bone anchors with curvilinear platforms, and/or abutments and/or artificial teeth with curvilinear platform engagement portions. Such kits feature a large number of bone anchors and/or abutments and/or artificial teeth with different shapes and sizes such that a dentist or surgeon could select from among many to obtain a precise fit in a given application.

The components of the prostheses of the invention can be made by any method known for producing shaped items composed of the same material as the implants. For example, titanium bone anchors with a curvilinear platform can be made by first preparing a mold of the bone anchor, and then adding melted titanium to the mold. Upon cooling, the titanium will solidify with the shape of the mold. As another example, small pieces of titanium can be milled into the desired shape using, e.g., an automatically controlled CNC machine that removes metal from the titanium piece until it reaches the shape of the desired bone anchor with a curvilinear platform. Other components (e.g., abutments with a curvilinear bottom surface) of the prosthesis could be made using the same processes.

The prostheses of the invention could be implanted in a subject by adapting the surgical techniques used for implanting conventional dental prostheses. For example, as a first step a socket for holding the bone anchor can be drilled into a jawbone. A bone anchor with a curvilinear platform that mimics the natural arch of the external bone surface can then be selected and inserted in the prepared socket in an orientation where the bone surface is aligned with the curvilinear platform. The bone anchor can be covered with flaps of gingival tissue, or all or part of it can be covered with a temporary protective cap or temporary healing abutment. Alternatively, the bone anchor can be left exposed. In any case, the socket is typically allowed to heal so that the bone anchor becomes rigidly affixed to the bone. At this time, a corresponding restorative abutment is selected having a bottom surface shaped to complement the top surface of the platform to the bone anchor component. The abutment design is selected to compliment the particular indexing configuration of the corresponding bone anchor (e.g., internal polygon, external polygon, internal taper or index, or external taper). The selected abutment is then attached to the bone anchor by a conventional method (e.g., using a fixation screw or an adhesive). An artificial tooth can then be attached to the abutment to yield an implanted prosthesis.

The foregoing describes one version of a prosthesis of the invention. Nonetheless, there are also several other versions of the prosthesis within the invention. Many of these feature components of conventional implants (e.g., those with flat platformed bone anchors) such as an anti-rotational, indexing wrench-engaging device that can take the form of an external polygonal nut (e.g., with three to eight or more sides) or an internal polygonal socket (e.g., that can be engaged with an allen wrench-type device). Accordingly, the invention is further described in the following examples, which do not limit the scope of the invention described in the claims.

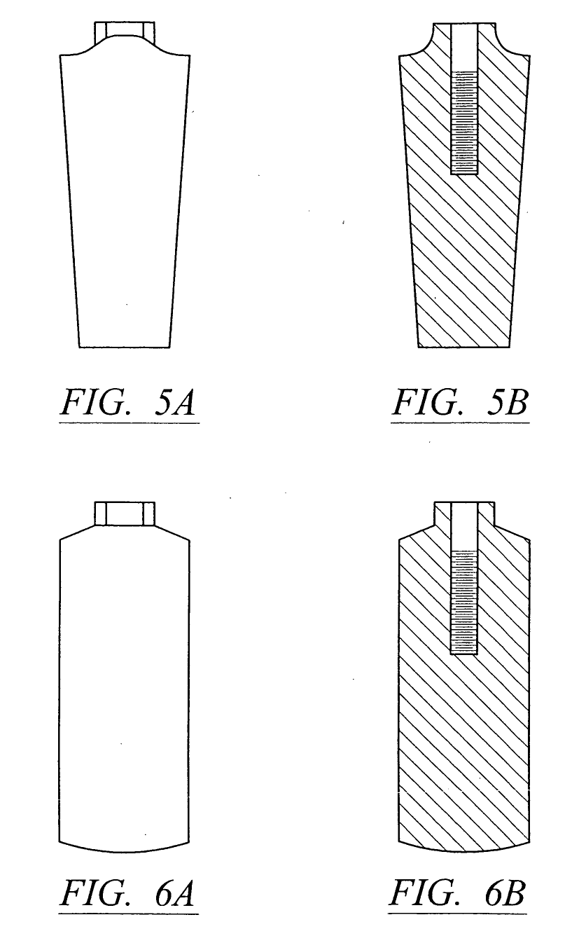

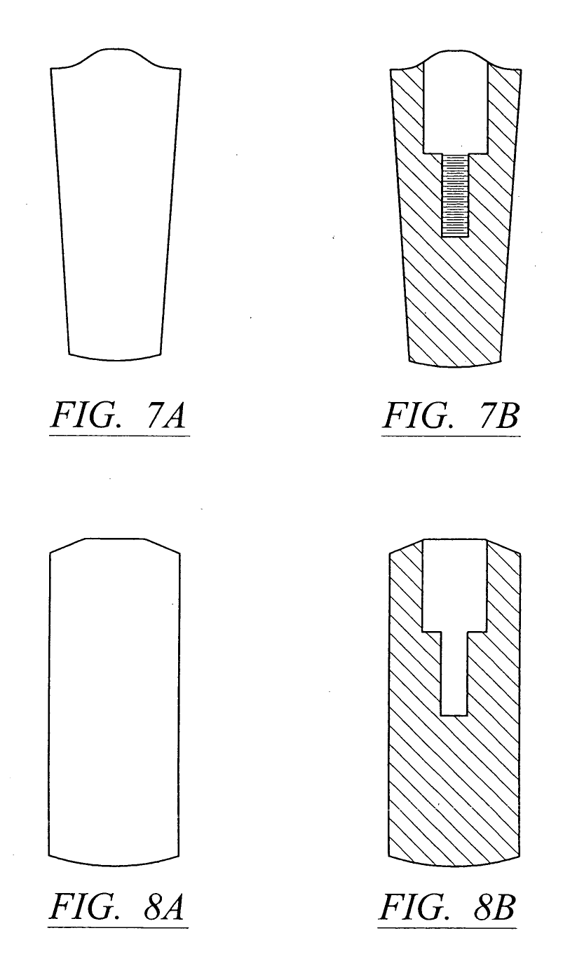

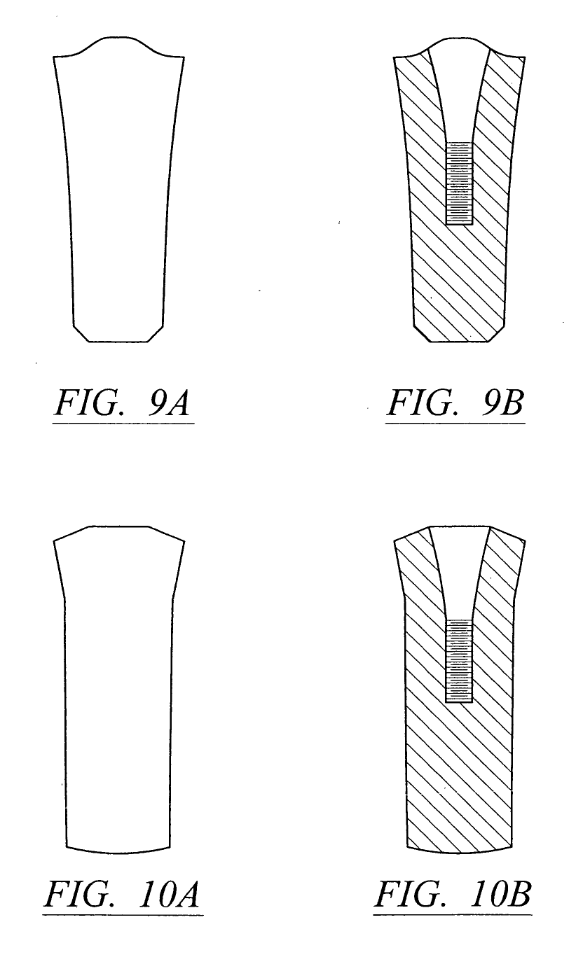

Examples of variations of the bone anchors of the invention are shown in FIGS. 5A-10B. The bone anchors shown in FIGS. 5A, 5B, 6A, and 6B feature an external hexagonal, indexing device, the former with a curved platform and the latter with a straight line non-flat platform. The bone anchors shown in FIGS. 7A, 7B, 8A and 8B feature an internal hexagonal indexing device, the former with a curved platform and the latter with a straight line non-flat platform. The bones anchors shown in FIGS. 9A, 9B, 10A, and 10B feature an internal taper indexing device, the former with a curved platform and the latter with a straight line non-flat platform. Flat-platformed bone anchors with such indexing devices are commercially available from several sources including model number OSS411 from Implant Innovations, Inc. (3i; Palm Beach Gardens, Fla.); catalog number SDCA796-0 from Nobel Biocare AB (Goteborg, Sweden); model number 45-0463 from Friadent Gmbh (Mannheim, Germany); model number 043.023S from Institut Straumann AG; and others from Paragon Implant Company (Encino, Calif.). Bone anchors within the invention with such various indexing devices might be made by replacing the flat platform of the foregoing devices with a non-flat or curvilinear platform.

From the foregoing it can be appreciated that the prostheses of the invention make it easier to achieve an ideal placement of an implant in bone. Thus, in comparison to conventional prostheses, those of the invention provide improved indexing, enhanced esthetics, superior bone stability, and improved implant retention.

While the above specification contains many specifics, these should not be construed as limitations on the scope of the invention, but rather as examples of preferred embodiments thereof. Many other variations are possible. For example, although the foregoing embodiments mainly relate to two-stage dental prostheses, this technology might also be applied to one-stage implants where the implant has a curvilinear portion at the site to be aligned with the external bone surface. This would establish a curvilinear shoulder which would be compatible with the shape of the healthy bone, in close proximity to the bone (e.g., 1.5 to 3 mm). And although the invention has been described in terms of dental prostheses, other embodiments that employ a bone anchor, pin, or bone screw are also within the invention. For example, bone screws used in surgical repairs of the spine that have a curved portion at the site to be aligned with the external surface of a vertebra are within the invention. Accordingly, the scope of the invention should be determined not by the embodiments illustrated, but by the appended claims and their legal equivalents.

What is claimed is:

1. A bone anchor for use in a prosthesis, the bone anchor having a bone attachment portion and a platform portion, the bone attachment portion being adapted to secure the bone anchor in a bone, and the platform portion having a non-flat top surface.

2. The bone anchor of claim 1, wherein the prosthesis is a two-stage dental prosthesis comprising the bone anchor and an abutment having a platform engagement portion that can be flushly mated with the platform portion of the bone anchor, the bone anchor further comprising an abutment acceptor adapted to engage the abutment.

3. The bone anchor of claim 1, wherein the prosthesis is a two-stage dental prosthesis comprising the bone anchor, an abutment, and an artificial tooth adapted to engage the abutment and the bone anchor, the bone anchor further comprising an abutment acceptor adapted to engage the abutment, and the artificial tooth having a bottom surface portion that can be flushly mated with the platform portion of the bone anchor.

4. The bone anchor of claim 1, wherein the non-flat top surface of the platform portion has a curvilinear shape.

5. The bone anchor of claim 4, wherein the non-flat top surface of the platform portion has a convex hyperbolic shape.

6. The bone anchor of claim 4, wherein the non-flat top surface of the platform portion has a regular curvilinear shape.

7. The bone anchor of claim 4, wherein the non-flat top surface of the platform portion has an irregular curvilinear shape.

8. The bone anchor of claim 4, wherein the non-flat top surface of the platform portion has a concave shape.

9. The bone anchor of claim 1, wherein the non-flat top surface of the platform portion has a shape comprised of at least two non-parallel flat surfaces.

10. The bone anchor of claim 1, further comprising an external polygonal indexing device.

11. The bone anchor of claim 1, further comprising an internal polygonal indexing device.

12. The bone anchor of claim 1, further comprising an internal tapered indexing device.

13. A dental prosthesis comprising a bone anchor, an abutment, and an artificial tooth, the bone anchor comprising a first abutment acceptor adapted to engage the abutment, and a platform portion having a non-flat top surface; the abutment having a bone anchor connection portion adapted to engage the first abutment acceptor, a platform engagement portion that can be flushly mated with the platform portion of the bone anchor, and an artificial tooth connection portion adapted to engage the artificial tooth; and the artificial tooth comprising a second abutment acceptor adapted to engage the abutment.

14. The dental prosthesis of claim 12, wherein the non-flat top surface of the platform portion of the bone anchor has a curvilinear shape, and the platform engagement portion has a bottom surface having a shape complementary to the non-flat top surface of the platform portion of the bone anchor.

15. The prosthesis of claim 13, wherein the non-flat top surface of the platform portion of the bone anchor has a convex hyperbolic shape and the bottom surface of the platform engagement portion of the abutment has a concave hyperbolic shape.

16. The prosthesis of claim 13, wherein the non-flat top surface of the platform portion of the bone anchor has a regular curvilinear shape.

17. The prosthesis of claim 13, wherein the non-flat top surface of the platform portion of the bone anchor has an irregular curvilinear shape.

18. The prosthesis of claim 13, wherein the non-flat top surface of the platform portion of the bone anchor has a concave shape and the bottom surface of the platform engagement portion of the abutment has a convex shape.

19. The prosthesis of claim 13, wherein the non-flat top surface of the platform portion of the bone anchor has a shape comprised of at least two non-parallel flat surfaces.

20. A dental prosthesis comprising a bone anchor, an abutment, and an artificial tooth, the bone anchor comprising a first abutment acceptor adapted to engage the abutment, and a platform portion having a non-flat top surface; the abutment having a bone anchor connection portion adapted to engage the first abutment acceptor, and an artificial tooth connection portion adapted to engage the artificial tooth; and the artificial tooth comprising a second abutment acceptor adapted to engage the abutment, and a platform engagement portion that can be flushly mated with the platform portion of the bone anchor.

21. The dental prosthesis of claim 20, wherein the non-flat top surface of the platform portion of the bone anchor has a curvilinear shape, and the platform engagement portion has a bottom surface having a shape complementary to the non-flat top surface of the platform portion of the bone anchor.

22. The prosthesis of claim 20, wherein the non-flat top surface of the platform portion of the bone anchor has a convex hyperbolic shape and the bottom surface of the platform engagement portion has a concave hyperbolic shape.

23. The prosthesis of claim 20, wherein the non-flat top surface of the platform portion of the bone anchor has a regular curvilinear shape.

24. The prosthesis of claim 20, wherein the non-flat top surface of the platform portion of the bone anchor has an irregular curvilinear shape.

25. The prosthesis of claim 20, wherein the non-flat top surface of the platform portion of the bone anchor has a concave shape and the bottom surface of the platform engagement portion has a convex shape.

26. The prosthesis of claim 20, wherein the non-flat top surface of the platform portion of the bone anchor has a shape comprised of at least two non-parallel flat surfaces.

27. A kit comprising at least a first bone anchor for use in a prosthesis and a second bone anchor for use in a prosthesis, the first and second bone anchors each having a bone attachment portion being adapted to secure each bone anchor in a bone, and a platform portion having a non-flat top surface, wherein the first and second bone anchor differ from each other in at least one dimensional parameter selected from the group consisting of: size and shape.
